(19) United States
(12) Patent Application Publication
(10) Pub. No.: US 2013/0178076 A1
(43) Pub. Date: Jul. 11, 2013

(54) BOARD-TO-BOARD CONNECTOR

(71) Applicant: SHENG-YUAN HUANG, New Taipei City (TW)

(72) Inventor: SHENG-YUAN HUANG, New Taipei City (TW)

(73) Assignee: Cheng Uei Precision Industry Co., LTD., New Taipei City (TW)

(21) Appl. No.: 13/345,667

(22) Filed: Jan. 6, 2012

(51) Int. Cl. H01R 12/73

(52) U.S. Cl. 439/65

(57) ABSTRACT

A board-to-board connector includes a male board connector and a female board connector mated with each other and having the same structure. Each board connector includes an insulating housing defining a row of first terminal grooves and a row of second terminal grooves. A plurality of first terminals is retained in the first terminal grooves respectively. A plurality of second terminals is positioned in the second terminal grooves respectively. The male board connector and the female board connector are engaged with each other to make the first terminal and the corresponding second terminal electrically interconnected steadily. The male board connector and the female board connector have the same structure. According to the present invention, it needs only one mold to produce the board-to-board connector and the cost of production will be accordingly lowered.

### BACKGROUND OF THE INVENTION

1. Field of the Invention

The present invention relates to a connector, and more particularly to a board-to-board connector.

2. The Related Art

In the electronic industry, a board-to-board connector is often used to realize an electrical connection between two different printed circuit boards. The board-to-board connector includes a male connector and a female connector mated with each other. The male connector includes a male housing and a plurality of male terminals assembled in the male housing. The female connector includes a female housing and a plurality of female terminals assembled in the female housing. When the male connector is engaged with the female connector, the male terminals electrically contact with the female terminals. However, the conventional board-to-board connector has different structures of the male connector and the female connector because the male terminals are different from the female terminals and accordingly the male housing is different from the female housing. As a result, it needs two different molds to produce the board-to-board connector and the cost of production is very high.

### SUMMARY OF THE INVENTION

Accordingly, an object of the present invention is to provide a board-to-board connector. The board-to-board connector includes a male board connector and a female board connector mated with each other to be connected together and having the same structure. Each board connector includes an insulating housing which has a bottom wall, a first side wall and a second side wall protruding upward from two opposite sides of the bottom wall and paralleling to each other. An inserting wall protrudes upward on a substantial middle of the bottom wall and is apart parallelly located between the first side wall and the second side wall. The first side wall defines a row of first terminal grooves each riding the first side wall. A row of second terminal grooves of substantial U-shape each is opened across the bottom wall and two face-to-face inner sides of the inserting wall and the second side wall. A plurality of first terminals each has a plug portion of substantial U-shape retained in the corresponding first terminal groove. A plurality of second terminals each has a first contact arm, a second contact arm and a connecting arm connected between two bottom ends of the first contact arm and the second contact arm. The second terminal is positioned in the corresponding second terminal groove with the first contact arm and the second contact arm inclining towards each other to make tops thereof project out of the second terminal groove. The male board connector and the female board connector are engaged with each other by means of the first side walls being respectively inserted between the inserting walls and the second side walls, to make the plug portion of the first terminal elastically and electrically clamped between the tops of the first contact arm and the second contact arm of the corresponding second terminal.

As described above, the board-to-board connector includes the male board connector and the female board connector of which both have the same structure. So, it needs only one mold to produce the board-to-board connector and the cost of production is accordingly lowered.

### BRIEF DESCRIPTION OF THE DRAWINGS

The present invention will be apparent to those skilled in the art by reading the following description thereof, with reference to the attached drawings, in which:

FIG. 1 is an assembled, perspective view of a board-to-board connector in accordance with the present invention;

FIG. 2 is an exploded, perspective view of the board-to-board connector shown in FIG. 1;

FIG. 3 is an exploded, perspective view of one board connector of the board-to-board connector shown in FIG. 2;

FIG. 4 is a perspective view of a first terminal of the board connector shown in FIG. 3;

FIG. 5 is a perspective view of a second terminal of the board connector shown in FIG. 3; and

FIG. 6 is a cross-sectional view of the board-to-board connector along line A-A of FIG. 1.

### DETAILED DESCRIPTION OF THE EMBODIMENT

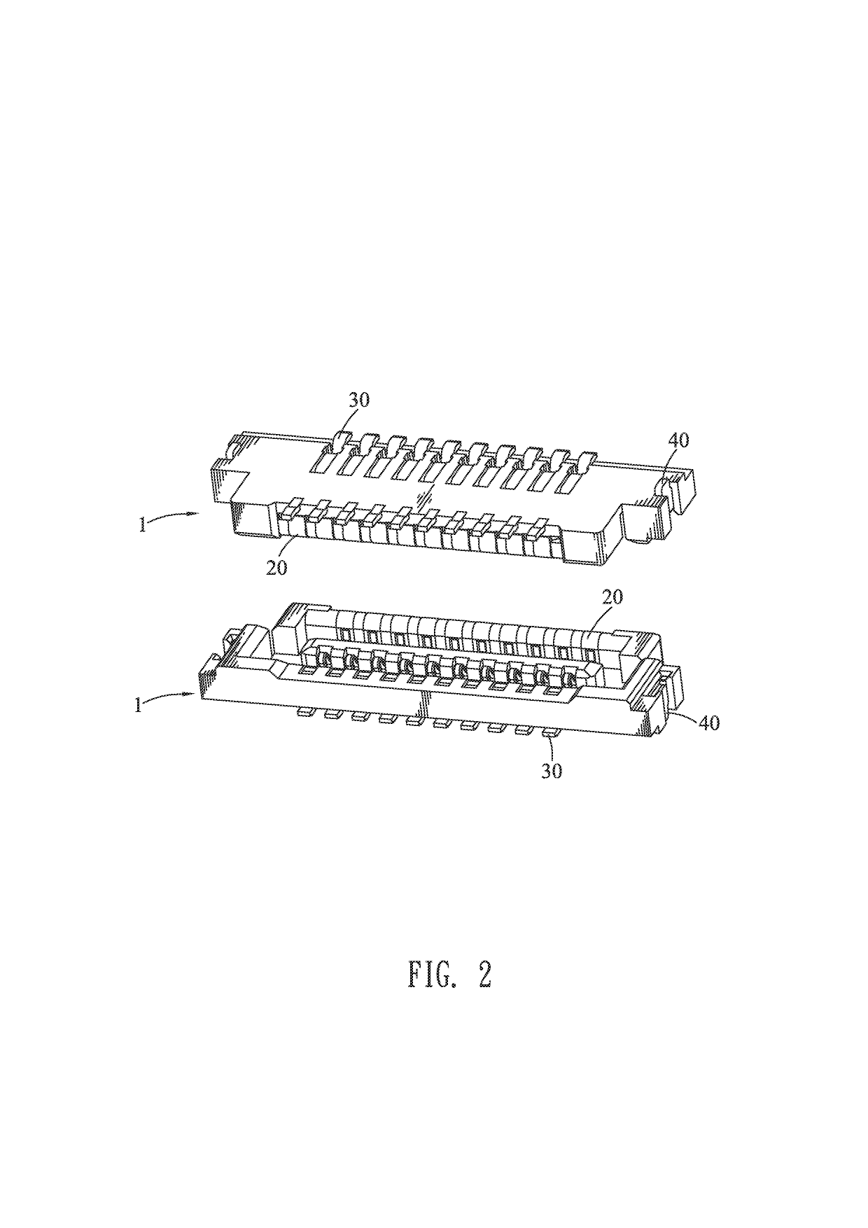

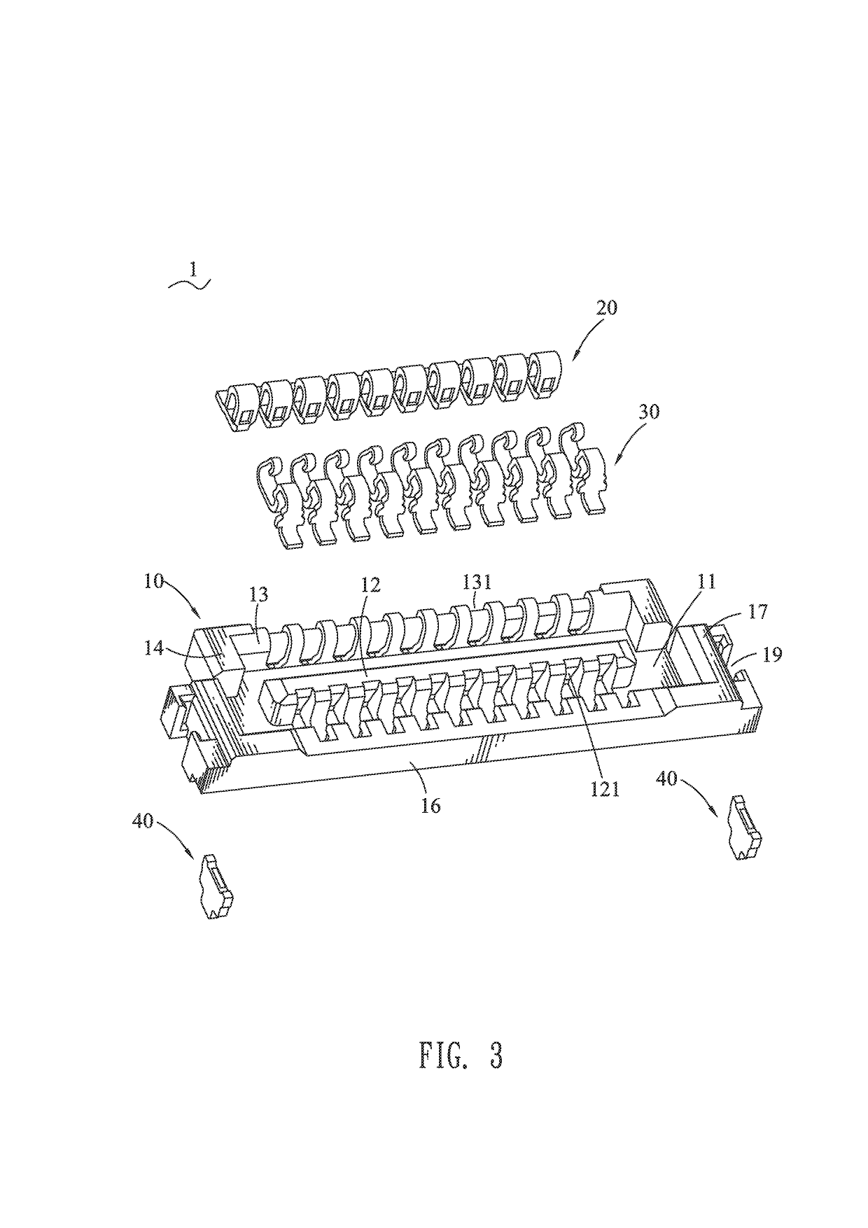

Referring to the drawings in greater detail, and first to FIGS. 2-3, an embodiment of the invention is embodied in a board-to-board connector 100. The board-to-board connector 100 includes a male board connector 1 and a female board connector 1 mated with each other to be connected together and having the same structure. Each board connector 1 includes an insulating housing 10, a plurality of first terminals 20 and a plurality of second terminals 30.

With reference to FIG. 3, the insulating housing 10 has a bottom wall 11, a first side wall 13 and a second side wall 16 protruding upward from two opposite sides of the bottom wall 11 and paralleling to each other. An inserting wall 12 protrudes upward on a substantial middle of the bottom wall 11 and is apart parallelly located between the first side wall 13 and the second side wall 16. The first side wall 13 defines a row of first terminal grooves 131 each riding the first side wall 13. A row of second terminal grooves 121 of substantial U-shape each is opened across the bottom wall 11 and two face-to-face inner sides of the inserting wall 12 and the second side wall 16. Two opposite ends of the bottom wall 11 protrude upward to form a pair of end walls 17 of which each defines an inserting slot 19 vertically penetrating therethrough. Each board connector 1 further includes a pair of fastening slices 40 inserted in the inserting slots 19 respectively and stretching out of bottom sides of the end walls 17. The second side wall 16 has a longer length than the first side wall 13. The end walls 17 are connected with two opposite ends of the second side wall 16. Two opposite ends of the first side wall 13 protrude inward to form a pair of positioning walls 14 apart from the corresponding end walls 17.

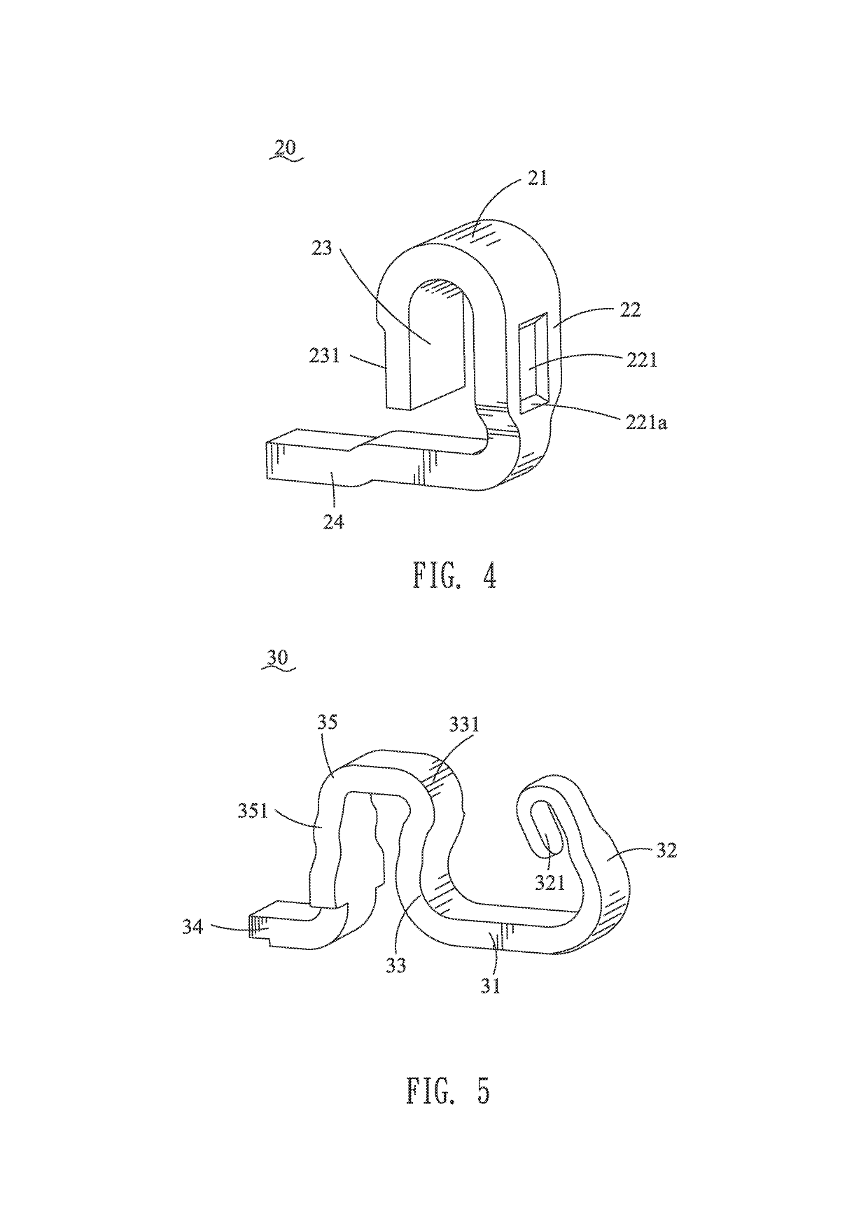

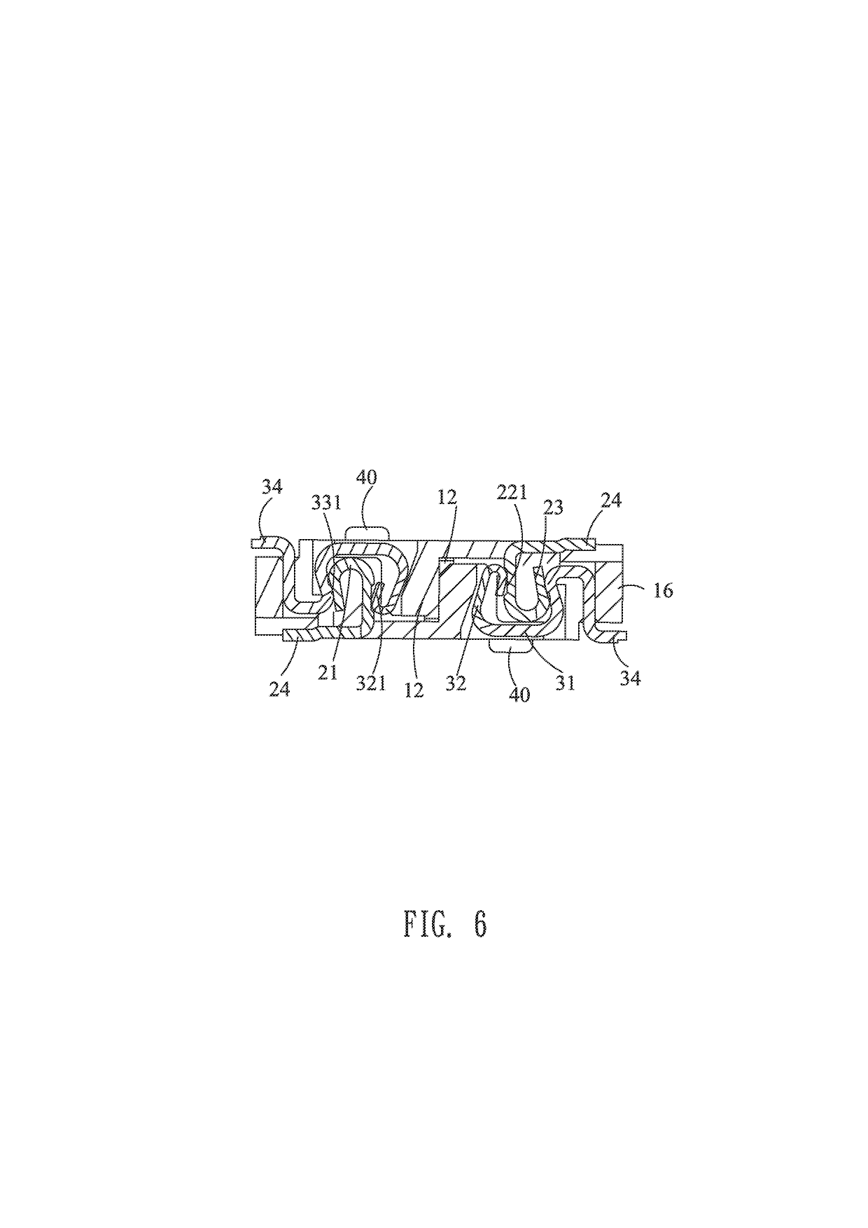

Referring to FIG. 4 and FIG. 6, each of the first terminals 20 has a plug portion 21 of substantial U-shape retained in the corresponding first terminal groove 131 of the insulating housing 10. The plug portion 21 of the first terminal 20 has a first contact board 22 and a second contact board 23 connected by a connecting board 21 therebetween. Two opposite outer sides of the first contact board 22 and the second contact board 23 respectively define a first recess 221 in a substantial middle thereof and a second recess 231 at a distal end thereof. A distal end of the first contact board 22 extends sideward to form a first soldering tail 24 exposed out of the bottom wall 11.

Referring to FIGS. 5-6, each of the second terminals 30 has a first contact arm 32, a second contact arm 33 and a connecting arm 31 connected between two bottom ends of the first contact arm 32 and the second contact arm 33. The second terminal 30 is positioned in the corresponding second terminal groove 121 of the insulating housing 10 with the first contact arm 32 and the second contact arm 33 inclining towards each other to make tops thereof project out of the second terminal groove 121. The top of the first contact arm 32 of the second terminal 30 is bent inward and towards the first contact arm 32 to form a first contact portion 321. The top of the second contact arm 33 is acted as a second contact portion 331. The top of the second contact arm 33 curvedly extends oppositely to the first contact arm 32 to form a positioning arm 35 of which a distal end bends sideward to form a second soldering tail 34. The positioning arm 35 is secured in one vertical part of the second terminal groove 121 opened in the second side wall 16, and the second soldering tail 34 is exposed out of the bottom wall 11. Two opposite side edges of the positioning arm 35 oppositely protrude outward to form a plurality of fastening blocks 351 interfering with inner sides of the one vertical part of the corresponding second terminal groove 121 to secure the second terminal 30 in the insulating housing 10. A periphery inner side of the first recess 221 is slanted outward to form a guiding eave 221 a for the convenience of the first contact portion 321 entering into or going out of the first recess 221.

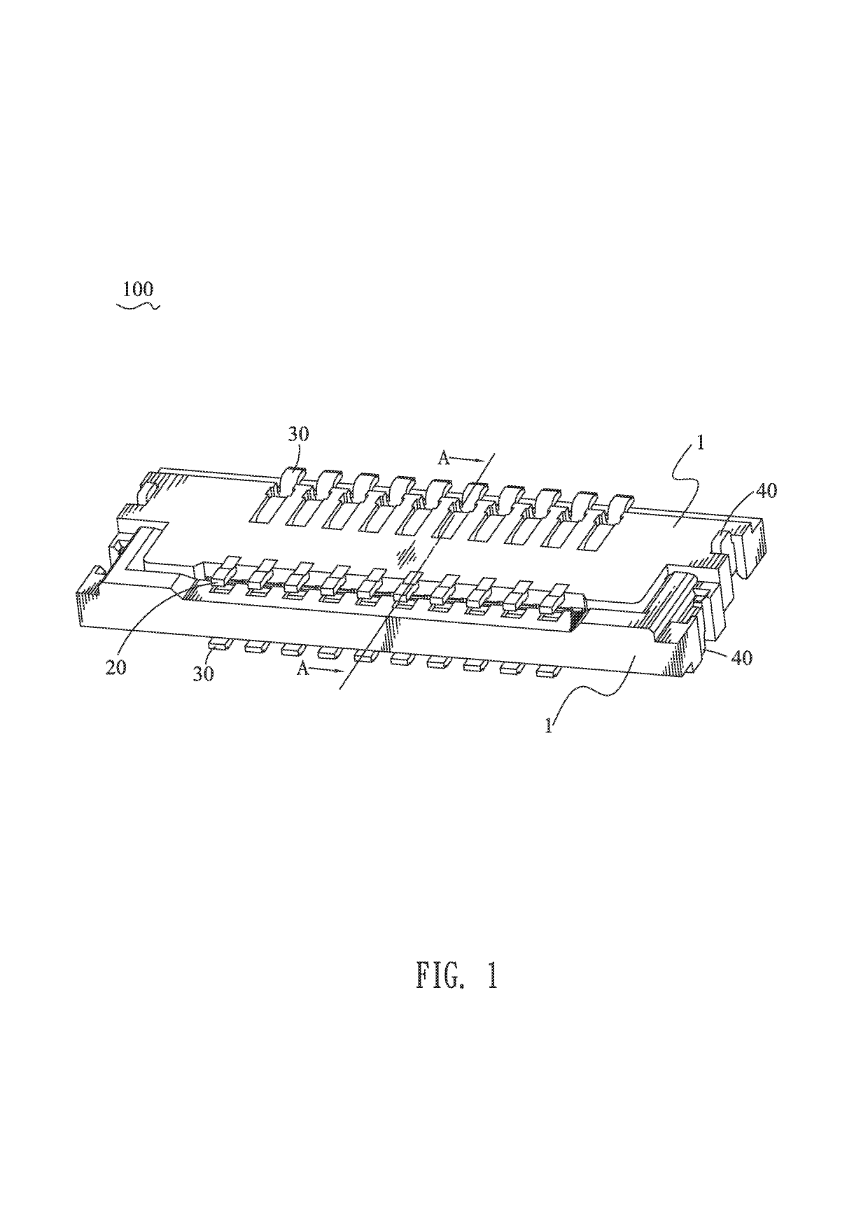

Referring to FIGS. 1-6, when the male board connector 1 is engaged with the female board connector 1, the positioning walls 14 of the male board connector 1 are positioned between the inserting wall 12 and the corresponding end walls 17 of the female board connector 1, and the end walls 17 of the male board connector 1 are restrained between two outer sides of the positioning walls 14 and the corresponding end walls 17 of the female board connector 1. The first side walls 13 are respectively inserted between the inserting walls 12 and the second side walls 16, to make the plug portion 21 of the first terminal 20 elastically and electrically clamped between the tops of the first contact arm 32 and the second contact arm 33 of the corresponding second terminal 30. In detail, the plug portion 21 of the first terminal 20 is inserted between the first contact arm 32 and the second contact arm 33 of the corresponding second terminal 30 with the first contact portion 321 and the second contact portion 331 located in the first recess 221 of the first contact board 22 and the second recess 231 of the second contact board 23.

As described above, the board-to-board connector 100 includes the male board connector 1 and the female board connector 1 of which both have the same structure. So, it needs only one mold to produce the board-to-board connector 100 and the cost of production is accordingly lowered.

The foregoing description of the present invention has been presented for the purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A board-to-board connector, comprising:
a male board connector and a female board connector mated with each other to be connected together and having the same structure, each board connector including:
an insulating housing having a bottom wall, a first side wall and a second side wall protruding upward from two opposite sides of the bottom wall and paralleling to each other, an inserting wall protruding upward on a substantial middle of the bottom wall and apart parallelly located between the first side wall and the second side wall, the first side wall defining a row of first terminal grooves each riding the first side wall, a row of second terminal grooves of substantial U-shape each being opened across the bottom wall and two face-to-face inner sides of the inserting wall and the second side wall;
a plurality of first terminals each having a plug portion of substantial U-shape retained in the corresponding first terminal groove; and
a plurality of second terminals of which each has a first contact arm, a second contact arm and a connecting arm connected between two bottom ends of the first contact arm and the second contact arm, the second terminal being positioned in the corresponding second terminal groove with the first contact arm and the second contact arm inclining towards each other to make tops thereof project out of the second terminal groove;
wherein the male board connector and the female board connector are engaged with each other by means of the first side walls being respectively inserted between the inserting walls and the second side walls, to make the plug portion of the first terminal elastically and electrically clamped between the tops of the first contact arm and the second contact arm of the corresponding second terminal.

2. The board-to-board connector as claimed in claim 1, wherein the plug portion of the first terminal has a first contact board and a second contact board connected together by a connecting board therebetween, two opposite outer sides of the first contact board and the second contact board respectively define a first recess in a substantial middle thereof and a second recess at a distal end thereof, the top of the first contact arm of the second terminal bends inward and towards the first contact arm to form a first contact portion, the top of the second contact arm is acted as a second contact portion, the plug portion of the first terminal is inserted between the first contact arm and the second contact arm of the corresponding second terminal with the first contact portion and the second contact portion being located in the first recess of the first contact board and the second recess of the second contact board.

3. The board-to-board connector as claimed in claim 2, wherein a periphery inner side of the first recess is slanted outward to form a guiding eave for the convenience of the first contact portion entering into or going out of the first recess.

4. The board-to-board connector as claimed in claim 2, wherein a distal end of the first contact board extends sideward to form a first soldering tail exposed out of the bottom wall, the top of the second contact arm curvedly extends oppositely to the first contact arm to form a positioning arm of which a distal end bends sideward to form a second soldering tail, the positioning arm is secured in one vertical part of the second terminal groove opened in the second side wall, and the second soldering tail is exposed out of the bottom wall.

5. The board-to-board connector as claimed in claim 4, wherein two opposite side edges of the positioning arm oppositely protrude outward to form a plurality of fastening blocks interfering with inner sides of the one vertical part of the corresponding second terminal groove to secure the second terminal in the insulating housing.

6. The board-to-board connector as claimed in claim 1, wherein two opposite ends of the bottom wall protrude upward to form a pair of end walls of which each defines an inserting slot vertically penetrating therethrough, each board connector further includes a pair of fastening slices inserted in the inserting slots respectively and stretching out of bottom sides of the end walls.

7. The board-to-board connector as claimed in claim 6, wherein the second side wall has a longer length than the first side wall, the end walls are connected with two opposite ends of the second side wall, two opposite ends of the first side wall protrude inward to form a pair of positioning walls apart from the corresponding end walls, when the male board connector is engaged with the female board connector, the positioning walls of the male board connector are positioned between the inserting wall and the corresponding end walls of the female board connector, and the end walls of the male board connector are restrained between two outer sides of the positioning walls and the corresponding end walls of the female board connector.
